(19) United States
(12) Patent Application Publication
(10) Pub. No.: US 2019/0087766 A1
(43) Pub. Date: Mar. 21, 2019

(54) SYSTEMS & METHODS OF LAW ENFORCEMENT PERFORMANCE MANAGEMENT

(71) Applicant: JONATHAN PARHAM, RAHWAY, NJ (US)

(72) Inventor: JONATHAN PARHAM, RAHWAY, NJ (US)

(21) Appl. No.: 16/163,336

(22) Filed: Oct. 17, 2018

Related U.S. Application Data
(60) Provisional application No. 62/546,617, filed on Aug. 17, 2017.

(51) Int. Cl. G06Q 10/06

(52) U.S. Cl. CPC G06Q 10/06398; G06Q 50/265; G06Q 10/06393

(57) ABSTRACT

A system and methods for law enforcement performance management is disclosed. The contemplated invention makes use of processors and modules for the collection, analysis and generation of recommendations for a law enforcement official's conduct as recorded by a variety of recording devices. Additional aspects of the contemplated invention contemplate generating a predictive analysis of a law enforcement official's future conduct based on the official's training, experience, and analysis of the official's previous conduct.

### CROSS-REFERENCE TO RELATED APPLICATIONS AND PRIORITY CLAIMS

This patent application is a Non-Provisional patent application and claims priority under 35 U.S.C. §119(e) to U.S. Provisional Patent Application Ser. No. 62/546,617, titled “Systems & Methods of aw Enforcement Performance Management” filed Aug. 17, 2017. The entire disclosure of the afore-mentioned patent application is incorporated by reference as if fully stated herein.

### FIELD OF THE INVENTION

The present invention is generally related to computer implemented methods, systems and computer program product directed to the management and analysis of law enforcement performance and other similar professions. Specifically, the use of computer implemented methods, systems and computer program product in the analysis & review of, and subsequent recommendation for, a law enforcement officer's/personnel's conduct during an incident.

### BACKGROUND OF THE INVENTION

Over the years, a number of law enforcement related incidents have resulted in civilian injury and death, with a number being as a result of officer misconduct, inadequate training, excessive force or the failure of the officer to meet certain standards set by his/her particular agency. As such, there exists a need for a way to check on the performance of law enforcement officers and provide areas of needed re-training and/or focus. There is also a need to prevent incidents of officer misconduct, including incidents of excessive force by identifying the officers most likely to use excessive force, based upon performance observed by a variety of devices, including, without limitation, the officer's body worn camera and motor vehicle recorder.

### SUMMARY OF THE INVENTION

Aspects of embodiments of the present invention contemplate systems, methods, computer program product and/or devices which are directed to the implementation and operational functionality of, inter alia, law enforcement performance management. Aspects of embodiments of the present invention contemplate using systems, methods, computer program product and/or devices to receive and use video captured from a law enforcement officer's body worn camera, traffic camera or mobile video recorder, placing it within a database, and comparing the officer's performance to agency best practices and/or other performance metrics.

The captured data allows the agency to pinpoint which officer's actions are inconsistent with the agency's minimum standards. The combination of officer video and database entry enables aspects of embodiments of the present invention to serve as a video based “Early Warning System”. A view of the collated data will also allow the agency to determine where to focus training efforts based upon agency-determined prioritization. The contemplated invention also serves as a holistic risk management tool—viewing both high risk, and high frequency events that historically lead to financial loss and officer injury.

An objective of the contemplated invention is to guide law enforcement leaders, trainers, and supervisors through a process that will identify errors in law enforcement performance that may lead to incidents of excessive force. Aspects of embodiments of the present invention contemplate data collection specific to officer error, allowing the agency to determine the areas in most need of training, counseling or discipline, ultimately resulting in better trained officers who deliver excellent police services to the community.

Aspects of embodiments of the present invention improve overall risk management in law enforcement because actual video footage of the officers' action is taken and used to determine if all applicable steps that are needed for the officer to successfully perform a function have been done properly.

The review of the officer's performance does not only identify the officer's possible missteps, aspects of embodiments of the present invention make it possible to have a holistic view of all of the officer's actions within the police department, requiring a secondary review of agency policy and training methodology, along with a tertiary review of organizational culture.

The contemplated invention, unlike other tools in the field, is the only one that uses actual officer video to conduct a comprehensive review which enables an agency to conduct a wide root cause analysis and evaluates mitigation measures to determine true error causation.

Aspects of embodiments of the present invention contemplate a system for law enforcement performance management, which includes one or more processors, where the one or more processors performs a predefined set of basic operations in response to receiving a corresponding basic instruction selected from a predefined native instruction set of codes, memory, a search module in communication with the one or more processors, a data entry module in communication with the search module, where a user, such as an agency supervisor of the reviewed law enforcement officer/personnel, uses the data entry module to enter data into the system, and where collected data is from any one or more of: live stream video from a body worn camera, live stream video from a dash camera of a squad car or vehicle, manual input, recorded data, and one or more officer modules in communication with the one or more processors, and search and data entry modules, where the one or more officer modules may include one or more incident registers and an officer data register, where the one or more incident registers may include any one or more of: a data input sub-register, an agency standard sub-register, a comparative sub-register, a scoring sub-register and an actions taken sub-register, where each sub-register may include data structure(s). In an aspect of an embodiment of the present invention, each data structure may be assigned a value.

In an aspect of an embodiment of the present invention, the search module of the system may include registers for receiving data based on any one or more of: search criteria, cases.

In an aspect of an embodiment of the present invention, the data entry module of the system may include registers for receiving data on any one or more of: personnel information, incident information, agency name. In one aspect, the data received may be used to populate any one or more of: the incident and officer data register(s) of the officer module(s).

In an aspect of an embodiment of the present invention, the search module may include pointers directing the server to any one or more of: officer module registers, officer module sub-registers. In another aspect, the pointers may point to the actual location of the relevant content of the registers.

In an aspect of an embodiment of the present invention, the system may include a graphical user interface module which, in turn, may include a plurality of graphical interface pages relating to any one or more of: the data entry module, search module, officer module registers. The graphical user interface module may be connected with different display devices that enable the display of the graphical interfaces. In another aspect, the graphical interfaces enable users to navigate the system easily while using the system.

In an aspect of an embodiment of the present invention, the officer sub-registers may be located or positioned in close proximity with one another. This enables fast and efficient analysis of the data contained within the sub-registers.

In an aspect of an embodiment of the present invention, the data structure(s) of the officer module agency standard sub-register may include at least one predetermined KPI.

Another aspect of an embodiment of the present invention contemplates a computer implemented method of law enforcement performance management, which may include, executing on one or more processors, which perform a predefined set of basic operations in response to receiving a corresponding basic instruction selected from a predefined native instruction set of codes, the steps of: storing predetermined values for agency KPIs within data structure(s) of an agency sub-register, scoring contents of data structure(s) of a data input sub-register, where the data structure(s) of a data input sub-register corresponds with data structure(s) of the agency sub-register, and where the scoring is done by allocating scores to the contents where the contents match with the values of the corresponding data structure(s) of the agency sub-register, determining action to be taken based on the scoring, where action to be taken includes any one or more of: no action, commendation, counseling, training needed, forward to internal affairs, roll call, where each action to be taken has a predetermined value and the action to be taken is based on comparing the scored value with the predetermined value of each action to be taken.

In another aspect of an embodiment of the present invention, the computer-implemented method may include the step of operating a search module, where such step may include the execution of a set of machine codes selected from the native instruction set, and where operation of the search module may include receiving data based on any one or more of: search criteria, cases.

In another aspect of an embodiment of the present invention, the computer-implemented method may include the step of operating a graphical user interface module, where such step may include the execution of a set of machine codes selected from the native instruction set, where operation of the graphical user interface module may include displaying and operation of graphical interfaces pages relating to any one or more of: a data entry module, a search module an officer module.

In another aspect of an embodiment of the present invention, the computer-implemented method may include the step of operating a data entry module, where such step may include the execution of a set of machine codes selected from the native instruction set, where operation of the data entry module may include storing data within the sub-registers.

A further aspect of an embodiment of the present invention contemplates a computer program product with non-transitory computer readable medium having control logic stored on it for causing a processor to assess law enforcement performance, where the control logic may include computer readable code executable by one or more processors, for storing predetermined values for agency KPIs within data structure(s) of an agency sub-register, scoring contents of data structure(s) of a data input sub-register, where the data structure(s) of a data input sub-register corresponds with data structure(s) of the agency sub-register, and where the scoring is done by allocating scores to the contents where the contents match with the values of the corresponding data structure(s) of the agency sub-register, determining action to be taken based on the scoring, where action to be taken includes any one or more of: no action, commendation, counseling, training needed, forward to internal affairs, roll call, where each action to be taken has a predetermined value and the action to be taken is based on comparing the scored value with the predetermined value of each action to be taken.

In a further aspect of an embodiment of the present invention, the computer program product may include computer readable code for operating a search module, where operation of the search module may include receiving data based on any one or more of: search criteria, cases.

In a further aspect of an embodiment of the present invention, the computer program product may include computer readable code for operating a graphical user interface module, where operation of the graphical user interface module may include displaying and operation of graphical interfaces pages relating to any one or more of: a data entry module, a search module an officer module.

In a further aspect of an embodiment of the present invention, the computer program product may include computer readable code for operating a data entry module, where operation of the data entry module may include storing data within the sub-registers.

### BRIEF DESCRIPTION OF THE DRAWINGS

FIG. 1. illustrates an overview of an exemplary system according to an aspect of an embodiment of the present invention.

FIG. 2 illustrates an exemplary computer architecture of an officer module according to an aspect of an embodiment of the present invention.

FIG. 3 illustrates an exemplary computer architecture of a search module according to an aspect of an embodiment of the present invention.

FIG. 4 illustrates an exemplary computer architecture of a data entry module according to an aspect of an embodiment of the present invention.

FIG. 5 illustrates an exemplary process flow according to an aspect of an embodiment of the present invention

FIGS. 6A and 6B illustrate graphical interfaces according to aspects of embodiments of the present invention.

### DETAILED DESCRIPTION OF THE DRAWINGS

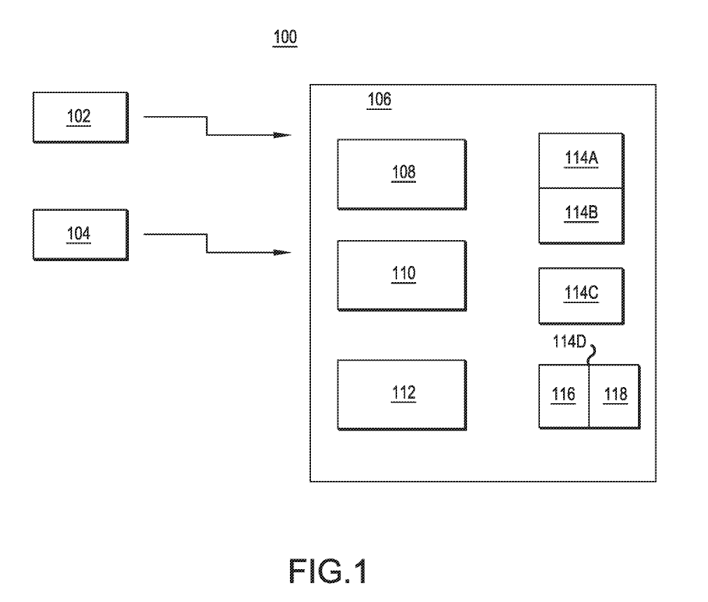

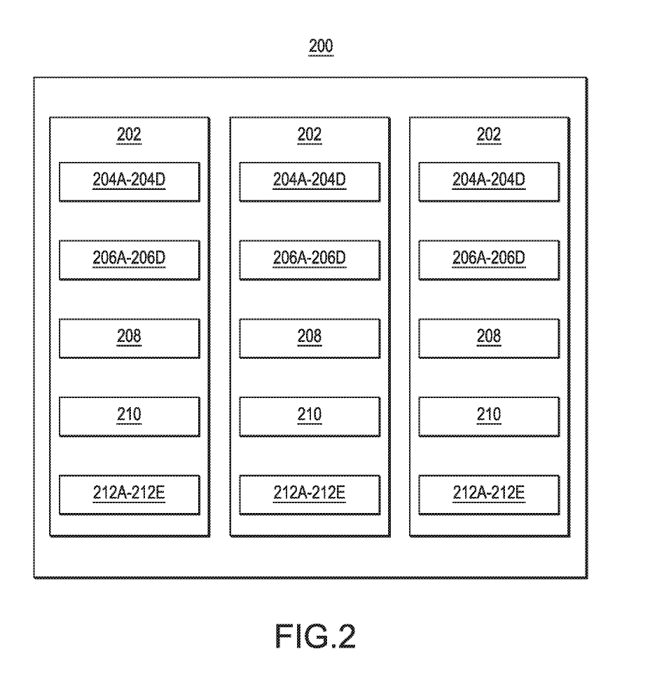

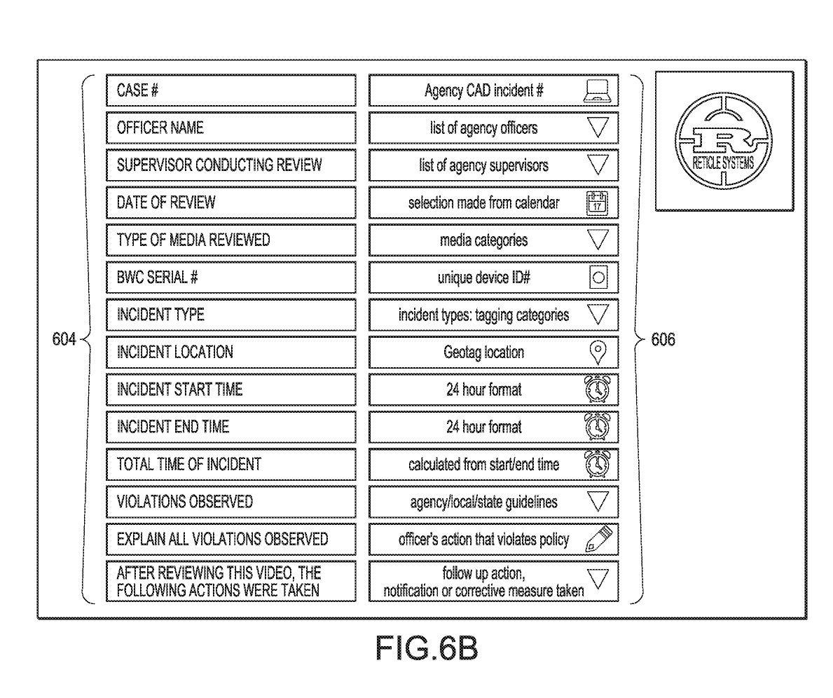

Referring now to FIGS. 1-6B, an exemplary system 100, exemplary computer architecture of an office module 100, exemplary computer architecture of a search module 200, exemplary computer architecture of a data entry module 400, exemplary process flow 500 and exemplary graphical interfaces 600 are shown according to aspects of embodiments of the present invention are shown. System 100 may include data collection components 102 and 104 which may include body worn camera(s) 102 and/or dash cameras 104 of law enforcement vehicles. It should be noted that other data collection devices or components may be used and that the discussion of body worn cameras and dash cameras herein is exemplary only and not limiting. Components 102, 104 may be in communication with main system component 106 which includes communication module 108 which communicates with data collection components 102, 104 to collect any audio or video recordings either as a live stream or as previously recorded data. With live stream data receipt, a supervisor, superintendent or reviewing personnel would be able to assess a law enforcement personnel's conduct as an incident occurs. Main system component 106 of system 100 may also include, in an aspect of an embodiment of the present invention, one or more processors 110 and memory 112. Main system component 106 may additionally include, according to aspects of embodiments of the present invention, operational modules 114A-114D. It should be noted that additional modules may be included, and that operational modules 114A-D are exemplary only and not limiting. In an aspect of an embodiment of the present invention, operational modules 114A-114D may include search module 114A, data entry module 114B, officer module 114C (also shown in more detail as officer module 200 in FIG. 2) and graphical user interface module 114D. In an aspect of an embodiment of the present invention, graphical user interface module 114D may include graphics interface generator 116 and graphics sub-processor 118. In an aspect of an embodiment of the present invention, graphics interface generator 116 generates exemplary graphics interface 600, which would be displayed on a display as shown in FIG. 6A, while graphics sub-processor 118 generates code embedded within tabs 602, sub-tabs 604 and other elements of graphics interface 600 to direct processor 110 to particular pointers 308 for the generation and population of graphics interface 600 with the corresponding data being pointed to. In an aspect of an embodiment of the present invention, graphical user interface module 114D may also direct processor 110 to particular pointers 308 using coded tabs in dropdown menus 606 for each item 604 shown in FIG. 6B.

Each one of operational modules 114A-114D may be in communication with communication module 108, processors 110 and memory 112, in which case, the operational modules receive the collected data from data collection components or devices 102 and 104 and even previously recorded data as stored in memory 112.

Referring now to FIG. 2, a more detailed view 200 of officer module 114C is shown according to aspects of embodiments of the present invention. Officer module 200 may include one or more one incident registers 202 within each officer module 200. Incident registers 202 may register data for each incident recorded by data collection components 102, 104 which may include any one or more of the following incidents: arrest, body worn camera (BWC) microphone check, crash investigation, criminal incident response, domestic violence, medical call, non-criminal citizen contact, prisoner transport, prisoner hospital security, suspicious event, traffic stop, use of force, vehicle pursuit etc. In an aspect of an embodiment of the present invention, officer module 200 may include an incident register 202 for each incident.

Each incident register 202 may further include data input sub-register 204 which receives the data entry (review points) entered by the reviewing personnel (which may include, activated artificial intelligence systems), agency standard sub-register 206, comparative sub-register 208, scoring sub-register 210 and actions taken sub-register 212. In an aspect of an embodiment of the present invention, each sub-register may include one or more one data structures 204A-204D, 206A-206D, 208A-208D, 210A-210D, 212A-212E within each sub-register. It should be noted that the numbers of sub-register, data structures, incident registers etc. as disclosed herein are for illustrative purposes only as additional or fewer sub-register, data structures, incident registers etc. are also contemplated as needed according to aspects of embodiments of the present invention.

In an aspect of an embodiment of the present invention, data structures 206A-206D may contain predetermined or previously entered values for each agency standard or agency KPIs and for comparison with the collected data as saved in data structures 204A-204D of data input sub-registers 204 for each incident register. These values may be numerical e.g. regular and/or weighted values, or binary (yes, no, 0, 1 etc.).

In an aspect of an embodiment of the present invention, each sub-register may be located in close proximity with one another. This enables quick and efficient retrieval of the data by processor 110 which in turn leads to a faster comparison of the values or scoring of the values in each sub-register, thereby enhancing the operation of system 100.

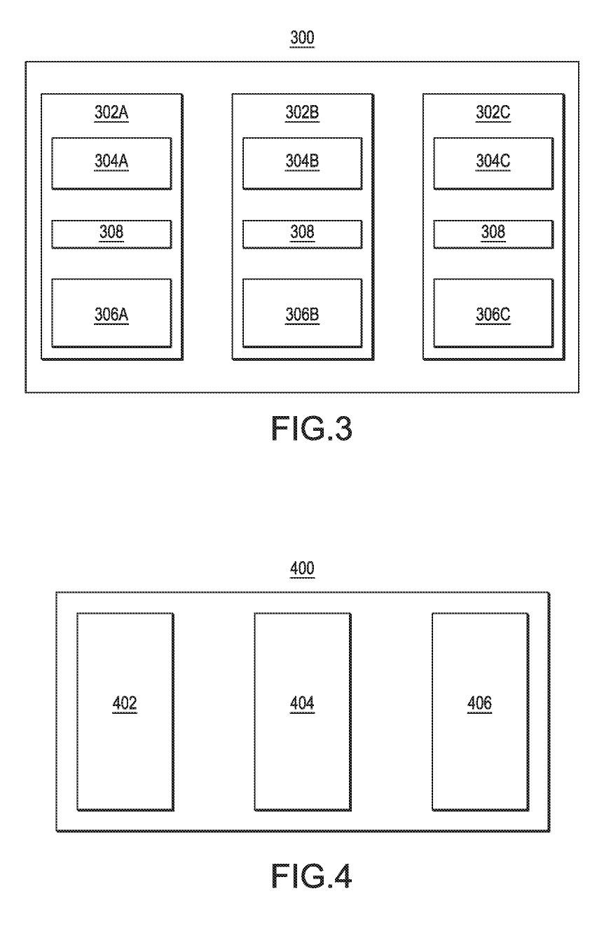

Referring now to FIG. 3, an exemplary search module 300 is shown according to aspects of embodiments of the present invention. Search module 300 may include registers 302A-302C for receiving data based on any one or more of: search criteria, cases, officer modules or any other operational feature of system 100. Search criteria may include case number, date, officer, supervisor (officer's supervisor), media type, body worn camera serial number, incident location, incident start time, incident end time, violations observed, incident disposition (no arrest, arrest, released at scene, transported to hospital, transferred over to other authority, warning issued etc.). Cases may be searched based on a number of categories, including, but not limited to, case number, date of review, date of incident, officer, supervisor, media type, body worn camera serial number, incident type, performance indicator, start time, end time, incident disposition and follow up. In an aspect of an embodiment of the present invention, each register 302A-302C, sub-register 304A-304C may contain pointers 308 directing processor 110 to any one or more of: officer module registers 202, officer module sub-registers 204-212 or even data structures of officer module 200. In effect, all data stored within system 100 may be addressed within search module 300 and directed to by pointers 308.

In an aspect of an embodiment of the present invention, search module 300 may include sub-processors 306A-306C which may assist in directing processor 110 to the appropriate register based on a search parameter entered in system 100. In an aspect of an embodiment of the present invention, sub-processors 306A-306C receive search parameters entered into system 100 and determine whether the parameters are matched with a pointer 308. Once a search parameter is matched, sub-processors 306A-306C then direct processor 110 to the location pointed to by pointers 308.

It should be noted that the identification and quantification of registers 302A-302C, sub-registers 304A-304C and sub-processors 306A-306C are exemplary only and not limiting as fewer or more of such components are also contemplated according to aspects of embodiments of the present invention.

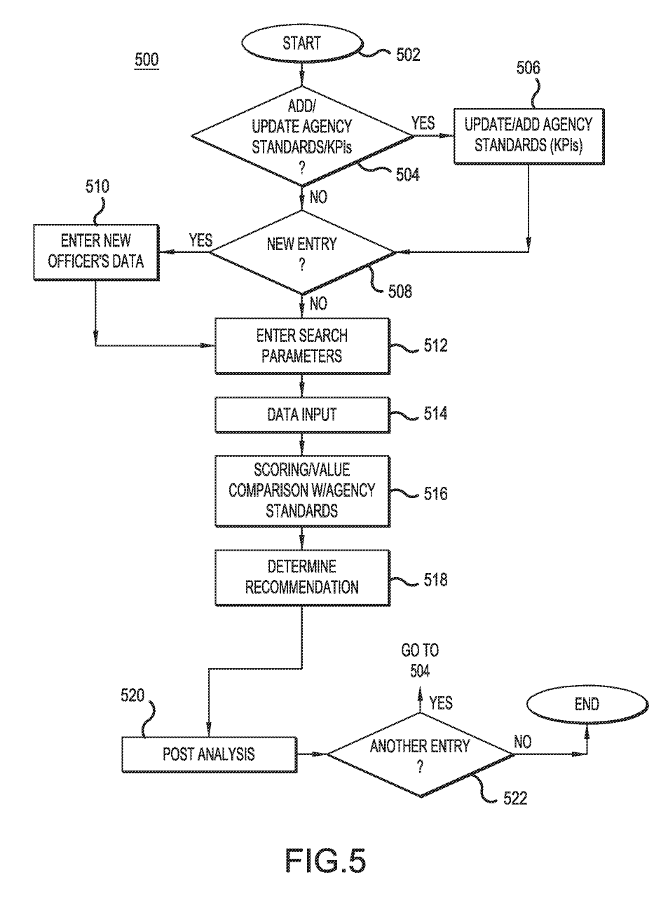

Referring now to FIG. 4, an exemplary data entry module 400 is shown according to aspects of embodiments of the present invention. Data entry module 400 may include registers 402-406 which may contain pointers 308 as generated by processor 110. In an aspect of an embodiment of the present invention, processor 110, upon determination that new data is to be added to system 100 or that an update to system 100 is to be made, generates, in conjunction with data entry module 400, pointers 308 which are then categorized in search module 300 into the different categories such as incident, officer module, personnel information, incident information, agency name etc. These may be saved in sub-registers 402A-404F of data entry module 400 and later transferred to the categorized locations in search module 300. In addition, data entry module 400 coordinates the data population of each component of the other modules, including, without limitation, officer module 200, search module 300 and graphical user interface module 114D.

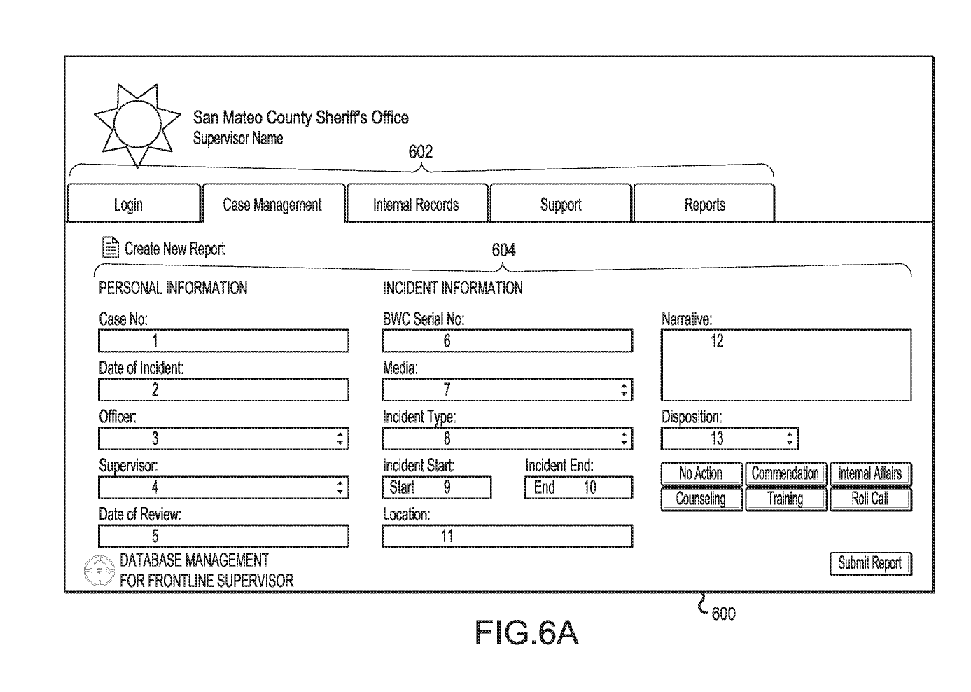

Referring now to FIG. 5, exemplary process 500 is shown according to aspects of embodiments of the present invention. Process 500 begins with a user, such as a supervisor, superintendent or reviewing personnel overseeing law enforcement officers/personnel, logging in to system 100 at step 502. In an aspect of an embodiment of the present invention, this step may also include interaction with artificial intelligence systems configured to conduct the operations and analysis disclosed herein. As such, the term “user” may refer to an actual human and/or artificial intelligence systems.

“Logging in” to system 100 may be made possible by using an access device such as a keyboard, computer-computer interface, mobile application or the like as is appreciated in the known art.

In interacting with the various modules of system 100, processor 110 performs numerous functions within system 100, including, determining which module to activate depending on the action desired of system 100 or the input to system 100. For instance, if a user intends to search system 100, search module 300 would be activated to assist processor 110 in conducting a search while also receiving search parameters from processor 110.

Once the user has logged in to system 100, system 100 (in one aspect of an embodiment of the present invention, this may be done by processor 110) queries the user in decisional step 504 as to whether the agency standards and/or parameters of key performance indicators (KPIs) would be added or updated. Some incidents and exemplary KPIs against which data points are compared are shown in Table 1 below.

TABLE 1
Incident Topics & Key Performance Indicators

| Incident Topic | Performance indicator |
|---|---|
| Arrest | Backup present |
| | Probable Cause Exists |
| | Advise subject of reason for arrest |
| | Search Incident to Arrest |
| | Double lock handcuffs |
| | Arrestee seat belted |
| BWC Mic Check | Check for damage to device |
| | Check battery status Indicator |
| | light check |
| | Notification of name, ID# and assignment |
| Crash Investigation | Check for injured |
| | Institute traffic control measures Complete |
| | Accident Investigation Report Remove |
| | debris |
| Criminal Incident | Coordinate response with additional units |
| Response | Activation of emergency lights when exceeding |
| | speed limit |
| | Activation of emergency lights, and reduction of |
| | speed when traveling through intersections |
| | Parking vehicle out of line of sight of target |
| | location |
| | Wait for Backup |
| Domestic Violence | Secure the scene |
| | Check for injuries |
| | Assist Victim |
| | Separate parties |
| | Determine if mandatory arrest exists |
| | Complete DV packet |
| Medical Call | Check call history with dispatch |
| | Provide appropriate medical care |
| | Collect information for report |
| Non-Criminal | Notify dispatch of location |
| Citizen Contact | Notify dispatch of subject description |
| | Backup present |
| | Explain reason for stop |
| | Courteous demeanor |

In aspects of embodiments of the present invention, incidents are stored within each register 202 of officer modules 200 while each KPI is stored with an assigned or predetermined value as data structures 204A-204D, 206A-206D, 208A-208D, 210A-210D, 212A-212E within their respective sub-registers. If the KPIs are to be updated, process 500 proceeds to step 506 whereby system 100 activates data entry module 400 which enables the user to update the existing KPIs of system 100 or add additional KPIs to system 100 by. For example, if the agency determines that it wishes to prioritize the existence of probable cause during an arrest, then, for a values based system, data entry module 400 would enable a higher value or score to be assigned to data structure value 206A of agency standards sub-register 206 for Probable Cause Exists.

System 100 also activates graphical user interface module 114D which then generates the corresponding graphical interfaces 600 which the user may use to enter the data. In an aspect of an embodiment of the present invention, where applicable, graphical user interface module 114D generates all graphical interfaces 600 that correspond with each step of process 100.

With the determination, in step 504 that an update of existing KPIs or that an additional KPI is being added to system 100, the user would then update or add the KPIs in step 506. The additional or updated KPIs would then be saved in memory 512. In another aspect of an embodiment of the present invention, the additional or updated KPIs would be saved in agency standard sub-registers 206A-206D access to which may be directed to by sub-processors 306A-306C using pointers 308 generated by processor 110. In an aspect of an embodiment of the present invention, processor 110 may undertake the directing.

If there are no updates to the existing agency KPIs or if there are no additions to the existing KPIs, process 500 proceeds from step 504 to step 508 where system 100 queries as to whether the user's input would be a new entry—meaning a new profile for a new officer. If the answer to decision step 508 is in the affirmative, the process proceeds to step 510 which the user enters the new officer's data (e.g. personal information, case number, date, officer name, supervisor name, incident type, media type involved, street address, zip code, start time, end time etc.). In an aspect of an embodiment of the present invention, the officer's personal information may be collected and stored, these may include the officer's training level, degree of experience, age, race, sex, stature (physical ability/size), etc. In another aspect of an embodiment of the present invention, information regarding the officer's training may also be collected. These may include the type of training undertaken by the officer within a certain time frame e.g. within the last year. These may include defensive tactics, conflict de-escalation, search & seizure, criminal law, constitutional law refresher, mental health refresher, crisis intervention training, cultural diversity, use of force update, vehicular pursuit update, handcuffing etc. Each officer training data may also be saved and assigned values in data structures of a training sub-register of officer module 200.

In an aspect of an embodiment of the present invention, each piece of data would be received, categorized, and assigned a pointer (which would also be saved in search module 300) by data entry module 400 and the data placed within the appropriate location within a newly generated officer module 200. In an aspect of an embodiment of the present invention, each data point for the officer may be scored and the scored value located within the sub-register data structures.

If the answer to decisional step 508 is in the negative, process 100 proceeds to step 512 where the user enters the search parameters for the search of an existing officer profile or officer module 200. In an aspect of an embodiment of the present invention, pointers 308 to existing officer profiles (as aspects of embodiments of the present invention contemplate multiple officer modules for multiple entries for more than one officer) may, in an aspect of an embodiment of the present invention, may located or stored within search module 300. Entry of a search parameter by the user is received by sub-processor 306 which matches the entry with a similar pointer 308 and directs processor 110 to the location of the sought profile or module 200.

Once the appropriate officer module 200 has been located, displayed (as a graphical interface 600), and enabled for data entry by data entry module 400, the user is able to enter or upload the data (video, audio-video, audio, etc.) and provide a review of same in step 514. In aspects of embodiments of the present invention, data entry may be implemented in a number of ways. First, it may be done automatically by calling the data from memory 112. The user may then review the data and input their review data into data input sub-register 204 of officer module 200. In another aspect of an embodiment of the present invention, the data may be entered automatically from a live streamed video obtained from a data collection component or device 102, 104. In an aspect of an embodiment of the present invention, the live streamed video may have tags imprinted onto each video frame of an incident as streamed from data collection devices 102, 104, with each tag indicating a data point stored in data input sub-registers 204. In an aspect of an embodiment of the present invention, each tag may be placed or imprinted upon frames of the streamed video, either manually by reviewing personnel or automatically upon the reviewed officer's declaration on the video stream e.g. “BWC mic check, ok”. The tagging may be done by processor 110 by execution of voice recognition code recognizing the voice commands or prompts provided by the officer in the video.

In an aspect of an embodiment of the present invention, data input may be done by reviewing personnel who, upon review of the video, reviews the video for each incident topic and assigns scores or values (e.g. yes/no, 1, 0 or numerical values) for each incident data point reviewed. For instance, if the video features an arrest, the reviewing personnel would review the video as to whether backup was present, probable cause existed, whether the subject was advised of the reason for the arrest, whether there was a search incident to the arrest, whether double lock handcuffs were deployed, whether the arrestee's seat belt was deployed etc. These are the data points which would be scored and compared with the predetermined values of the KPIs in agency standard sub-register 206.

Following data entry in step 512 (where the data is entered into, in one aspect of an embodiment of the present invention, data input sub-register 204) processor 110 then proceeds, to step 516 with the analysis of the entered data. In one aspect of an embodiment of the present invention, processor 110 may score the entered data and may apply weighted scores. For instance, if the reviewing personnel determines that the officer being reviewed in the video did not arrest the suspect in the video with any probably cause, then the reviewing personnel may score a “0” for the reviewed officer. In another aspect of an embodiment of the present invention, the analysis may involve merely providing a “yes”/“no” answer regarding the performance indicator e.g. “did probable cause exist”?; Data entry: “Yes”. The scored data or values are then stored in the data structures of scoring register 210.

In an aspect of an embodiment of the present invention, scoring sub-register 210 and agency standard sub-register 206 may be adjacent or in close proximity with one another to enable quick retrieval of the vales of each data structure and analysis by processor 110.

For a scored analysis aspect, processor 110, also in step 516, proceeds to tally up the scores in scoring sub-register 210 and compares the tallied scores against the tallied scores for agency standard sub-register 206, with processor 110 storing the results in comparative sub-register 208.

For a one to one comparative analysis, processor 110 may compare the values of each data structure in data input sub-register 204 against the baseline values in the corresponding data structure in agency standards sub-register 206. In an aspect of an embodiment of the present invention, the comparison may be a determination as to whether the values in each data structure 204 is less than, equal to or more than the values of data structures in agency standard sub-register 206.

Process 500 then proceeds to step 518 where processor 110, based on the values of the input data as compared to the values of the agency standards sub-register 206, makes a determination regarding recommended action for the reviewed officer. In an aspect of an embodiment of the present invention, the determination will be based on contents of actions taken sub-register 212 whose data structures includes values for different action recommendation to be made for the officer's conduct such as:

No Action—the video being reviewed requires no additional follow up and will be added to the database.

Commendation—the officers' actions are above the call of duty. A copy of this review will be forwarded to the Award Review Committee

Counseling—The officers' actions are inconsistent with Agency norms. The violation is minor and should be addressed with a formal Counseling Session. A copy of this review will be forwarded to the officer's immediate supervisor.

Training Needed—The officers' actions are inconsistent with Agency norms. The violation involves a lack of technical or procedural knowledge on the officer's part and should be addressed with a formal Training Session. A copy of this review will be forwarded to the officer's immediate supervisor, and the Training Bureau.

Forward to Internal Affairs—The officers' actions are inconsistent with Agency norms. The violation involves a violation of a rule, regulation, policy, procedure, order, or directive and shall be forwarded to the Internal Affairs Bureau for review.

Roll Call—The officers' actions reflect a commonly occurring issue and should be utilized to reinforce positive performance during a Roll Call Training session.

In an aspect of an embodiment of the present invention, each recommended action above may be assigned a value and if the value of the data input data structures are below those assigned to each recommended action, then the officer may be recommended the action. In another aspect of an embodiment of the present invention, the recommendation may be based on an overall tally of the values scored in scoring sub-register 210 in which case, the total tally of sub-register 210 is compared against the certain scoring levels of actions taken sub-register 212 e.g. if No Action is allotted a score of 20 and the total tally of scoring sub-register 210 is 20 then No Action is recommended. In an aspect of an embodiment of the present invention, recommendations of sub-register 212 may be based on each incident datapoint—for instance, if recommendation is sought for an officer's conduct as it pertains to probable cause, then the data structure bearing the reviewer's scoring in data input sub-register 204 for the officer's conduct as it pertains to probable cause would then form the basis for the recommendation and would be compared against each data structure in 212 (where each data structure pertains to recommended action).

In an aspect of an embodiment of the present invention, a range of values may be assigned to each recommended action. In which case, if a reviewer's scoring value for an officer's conduct for a particular incident data point falls within the range for a particular recommendation, then that recommendation would be followed.

After the action is determined in step 518, the recommended action may be sent to the officer, his/her agency, his/her supervisor and/or internal affairs in step 520. After step 520, the process proceeds to decisional step 522 which queries the user as to whether another entry is to be made. If the answer is in the affirmative, the process proceeds to step 504, otherwise the process ends.

In another aspect of an embodiment of the present invention, correlation and causation of systemic error maybe analyzed by system 100's use of an officer's training level, degree of experience, age, race, sex, stature and recency of core training relative to the event being reviewed. These factors may also be assigned certain values which may be factored into making an actions to be taken determination for the officer. In another aspect of an embodiment of the present invention, a cultural norm for an agency may be developed by reviewing and correlating these factors with historical data from and/or incidents across the agency.

In an aspect of an embodiment of the present invention, an agency may determine where additional training is required upon review of office modules 200 and the data collected therein. For instance, if a majority of the officers or personnel obtained low scores for a particular incident data point e.g. low scores for deploying double lock handcuffs for Arrest incidents, then system 100 would recommend training dealing with arresting procedures for the affected officers.

In an aspect of an embodiment of the present invention, determining the recommended action (follow up action) for the reviewed officer/personnel may take into consideration, the officer's training, education and experience where each of these aspects may, in one aspect of an embodiment of the present invention, be assigned values or scored.

The data collected, reviewed and analyzed may be used by an agency in efforts to mitigate officer error and poor conduct.

Aspects of embodiments of the present invention contemplate the use of modules in implementation of the process(es) outlined herein and operation of components of the system also disclosed herein. In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, “module” may represent operational cooperation between system components. For instance, the officer module may comprise of the one or more processors, memory, computer executable instructions (code) executable by the processor(s) and resident within memory location(s) etc. with each component being in communication with one or more other components in the module and each component working with the other component(s) to conduct the desired operation for which the module is configured to do e.g. comparison or scoring of data structure values(s). In a further aspect of an embodiment of the present invention, module components may also, in an operational context, be components of other modules. These modules may be components of server(s)/processor(s) which are configured to perform a predefined set of basic operations in response to receiving a corresponding basic instruction selected from a predefined native instruction set of computer executable codes. The modules then may include a set of machine codes selected from the native instructions set of the server(s)/processor(s) to perform specific functions and/or operations. The native instructions set is a discrete code recognized by the hardware processor(s) and may be built into the hardware processor(s) and is presents the way the system communicates with the hardware processor(s). In an aspect of an embodiment of the present invention, the native instructions set specify certain registers for arithmetic, addressing and/or control functions. In addition, the native instructions set can specify addressing modes which are utilized to interpret operands. Combination and/or permutations of the different native instructions may be done for more complex computer operations or functionality.

A further aspect of an embodiment of the present invention contemplates use of computer program product which may include a computer usable medium having control logic stored on it for causing processor 110 and, in other aspects, sub-processors 306 to perform all operations contemplated herein.

Aspect(s) of embodiment(s) of the present invention make use of hardware processor(s) configured to perform a predefined set of basic operations in response to receiving a corresponding basic instruction selected from a predefined native instruction set of codes.

Aspect(s) of embodiment(s) of the present invention make use of database system(s) which include data structure(s), register(s) and pointer(s).

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as outlined above, in the appended drawings and the claims presented below.

What is claimed is:

1. A system for law enforcement performance management, comprising:
at least one processor, wherein the at least one processor performs a predefined set of basic operations in response to receiving a corresponding basic instruction selected from a predefined native instruction set of codes;
memory;
a search module in communication with the at least one processor;
a data entry module in communication with the search module, wherein a user uses the data entry module to enter data into the system, wherein the data is collected from any one or more of: live stream body worn camera, manual input, recorded data; and
at least one officer module in communication with the at least one processor, and search and data entry modules, wherein the at least one officer module comprises of at least one incident register and an officer data register, wherein the at least one incident register comprises of any one or more of: a data input sub-register, an agency standard sub-register, a comparative sub-register, a scoring sub-register and an actions taken sub-register, wherein each sub-register comprises of at least one data structure.

2. The system of claim 1, wherein the search module comprises of registers for receiving data on any one or more of: search criteria, cases.

3. The system of claim 1, wherein the data entry module comprises of registers for receiving data on any on or more of: personnel information, incident information, agency name.

4. The system of claim 3, wherein data received is used to populate any one or more of: the at least one incident and officer data registers of the officer module.

5. The system of claim 1, wherein the search module comprises of pointers directing the server to any one or more of: officer module registers, officer module sub-registers.

6. The system of claim 1 further comprising of a graphical user interface module comprising a plurality of graphical interface pages relating to any one or more of: the data entry module, search module, officer module registers.

7. The system of claim 1, wherein the officer sub-registers are in close proximity with one another.

8. The system of claim 1, wherein the at least one data structure of the officer module agency standard sub-register comprises of at least one predetermined KPI.

9. A computer implemented method of law enforcement performance management, comprising, executing on at least one processor, which performs a predefined set of basic operations in response to receiving a corresponding basic instruction selected from a predefined native instruction set of codes, the steps of:
storing predetermined values for agency KPIs within at least one data structure of an agency sub-register;
scoring contents of at least one data structure of a data input sub-register, wherein the at least one data structure of a data input sub-register corresponds with at least one data structure of the agency sub-register, and wherein the scoring is done by allocating scores to the contents where the contents match with the values of the corresponding at least one data structure of the agency sub-register;
determining action to be taken based on the scoring, wherein action to be taken includes any one or more of: no action, commendation, counseling, training needed, forward to internal affairs, roll call, wherein each action to be taken has a predetermined value and the action to be taken is based on comparing the scored value with the predetermined value of each action to be taken.

10. The computer-implemented method of claim 9 further comprising the step of operating a search module, the step comprising execution of a set of machine codes selected from the native instruction set, wherein operation of the search module comprises of receiving data based on any one or more of: search criteria, cases.

11. The computer-implemented method of claim 9 further comprising the step of operating a graphical user interface module, the step comprising execution of a set of machine codes selected from the native instruction set, wherein operation of the graphical user interface module comprises of displaying and operation of graphical interfaces pages relating to any one or more of: a data entry module, a search module an officer module.

12. The computer-implemented method of claim 9 further comprising the step of operating a data entry module, the step comprising execution of a set of machine codes selected from the native instruction set, wherein operation of the data entry module comprises of storing data within the sub-registers.

13. A computer program product comprising a non-transitory computer readable medium having control logic stored therein for causing a processor to assess law enforcement performance, the control logic comprising computer readable code executable by at least one processor, for
storing predetermined values for agency KPIs within at least one data structure of an agency sub-register;
scoring contents of at least one data structure of a data input sub-register, wherein the at least one data structure of a data input sub-register corresponds with at least one data structure of the agency sub-register, and wherein the scoring is done by allocating scores to the contents where the contents match with the values of the corresponding at least one data structure of the agency sub-register;
determining action to be taken based on the scoring, wherein action to be taken includes any one or more of: no action, commendation, counseling, training needed, forward to internal affairs, roll call, wherein each action to be taken has a predetermined value and the action to be taken is based on comparing the scored value with the predetermined value of each action to be taken.

14. The computer program product of claim 13 further comprising computer readable code for operating a search module, wherein operation of the search module comprises of receiving data based on any one or more of: search criteria, cases.

15. The computer program product of claim 13 further comprising computer readable code for operating a graphical user interface module, wherein operation of the graphical user interface module comprises of displaying and operation of graphical interfaces pages relating to any one or more of: a data entry module, a search module an officer module.

16. The computer program product of claim 13 further comprising computer readable code for operating a data entry module, wherein operation of the data entry module comprises of storing data within the sub-registers.
